(19) United States
(12) Patent Application Publication
(10) Pub. No.: US 2025/0247800 A1
(43) Pub. Date: Jul. 31, 2025

(54) RANDOM ACCESS PROCEDURES FOR DISTRIBUTED ACCESS SYSTEMS

(71) Applicant: Lumine Group US Holdco Inc., Wilmington, DE (US)

(72) Inventors: Henry Ye, Andover, MA (US); Sujie Chen, Fanling (HK)

(73) Assignee: Lumine Group US Holdco Inc., Wilmington, DE (US)

(21) Appl. No.: 19/036,149

(22) Filed: Jan. 24, 2025

Related U.S. Application Data
(60) Provisional application No. 63/625,539, filed on Jan. 26, 2024.

(51) Int. Cl. H04W 56/00

(52) U.S. Cl. CPC H04W 56/00

(57) ABSTRACT

A method of synchronizing a user equipment (UE) with a network device, the method comprising: using at least one computer hardware processor to perform: receiving, at the network device, a synchronization request for establishing a data transmission session between the network device and the UE, wherein a detection window for the synchronization request is delayed by a shift value at the network device, the shift value being based on a stored network device delay; determining an estimated first round-trip delay between the UE and the network device based on the synchronization request received by the network device; determining a timing advance for the UE based on the estimated first round-trip delay and a shift value; and monitoring, by the network device, for an uplink communication with the determined timing advance applied at the UE for the uplink communication.

### RELATED APPLICATIONS

This application claims the benefit under 35 U.S.C. § 119(e) of U.S. Provisional Application Ser. No. 63/625,539, filed Jan. 26, 2024, and titled “RANDOM ACCESS PROCEDURES FOR DISTRIBUTED ACCESS SYSTEMS,” which is incorporated herein by reference in its entirety.

### BACKGROUND

In distributed antenna systems, multiple hardware components work together to provide network connectivity. Multiple antennas work to transmit information to and from a base station to provide network connectivity across an organizational structure.

### SUMMARY

Some embodiments provide for a method of synchronizing a user equipment (UE) with a network device, the method comprising: using at least one computer hardware processor to perform: receiving, at the network device, a synchronization request for establishing a data transmission session between the network device and the UE, wherein a detection window for the synchronization request is delayed by a shift value at the network device, the shift value being based on a stored network device delay; determining an estimated first round-trip delay between the UE and the network device based on the synchronization request received by the network device; determining a timing advance for the UE based on the estimated first round-trip delay and a shift value; and monitoring, by the network device, for an uplink communication based on the determined timing advance to be applied at the UE for the uplink communication.

In some embodiments, the method further comprises obtaining the stored network device delay based on intrinsic delay of hardware components and transport media.

In some embodiments, determining the timing advance for the UE comprises determining a value for the timing advance such that the uplink communication is expected to be received within the uplink receive window of the network device, and such that the uplink communication can be correctly decoded at the network device.

In some embodiments, the method further comprises: receiving, within the uplink receive window, the uplink communication; and transmitting an identification signal to the UE based on the uplink communication.

In some embodiments, determining the first round-trip delay between the UE and the network device comprises estimating the round-trip delay based on the synchronization request detection at the network device relative to a start of a synchronization request detection window; and determining the timing advance comprises adding the shift value to the estimated first round-trip delay.

In some embodiments, the synchronization request is a preamble message for a physical random access channel.

In some embodiments, a format of the preamble message is a B4 format.

In some embodiments, a window of overall round-trip delay detection range is extended to be between 25 to 60 μs.

In some embodiments, the timing advance is transmitted to the UE using a random access response signal.

In some embodiments, the network device is a base station.

Some embodiments provide for a system comprising at least one computer hardware processor; and at least one non-transitory computer readable storage medium storing processor executable instructions that, when executed by the at least one computer hardware processor, cause the at least one computer hardware processor to perform a method of synchronizing a user equipment (UE) with a network device, the method comprising: using at least one computer hardware processor to perform: receiving, at the network device, a synchronization request for establishing a data transmission session between the network device and the UE, wherein a detection window for the synchronization request is delayed by a shift value at the network device, the shift value being based on a stored network device delay; determining an estimated first round-trip delay between the UE and the network device based on the synchronization request received by the network device; determining a timing advance for the UE based on the estimated first round-trip delay and a shift value; and monitoring, by the network device, for an uplink communication based on the determined timing advance to be applied at the UE for the uplink communication.

In some embodiments, the system further comprises obtaining the stored network device delay based on intrinsic delay of hardware components and transport media.

In some embodiments, determining the timing advance for the UE comprises determining a value for the timing advance such that the uplink communication is expected to be received within the uplink receive window of the network device, and such that the uplink communication can be correctly decoded at the network device.

In some embodiments, determining the first round-trip delay between the UE and the network device comprises estimating the round-trip delay based on the synchronization request detection at the network device relative to a start of a synchronization request detection window; and determining the timing advance comprises adding the shift value to the estimated first round-trip delay.

Some embodiments provide for at least one non-transitory computer readable storage medium storing processor executable instructions that, when executed by the at least one computer hardware processor, cause the at least one computer hardware processor to perform a method of synchronizing a user equipment (UE) with a network device, the method comprising: using at least one computer hardware processor to perform: receiving, at the network device, a synchronization request for establishing a data transmission session between the network device and the UE, wherein a detection window for the synchronization request is delayed by a shift value at the network device, the shift value being based on a stored network device delay; determining an estimated first round-trip delay between the UE and the network device based on the synchronization request received by the network device; determining a timing advance for the UE based on the estimated first round-trip delay and a shift value; and monitoring, by the network device, for an uplink communication based on the determined timing advance to be applied at the UE for the uplink communication.

In some embodiments, the non-transitory computer-readable storage medium further comprises obtaining the stored network device delay based on intrinsic delay of hardware components and transport media.

In some embodiments, determining the timing advance for the UE comprises determining a value for the timing advance such that the uplink communication is expected to be received within the uplink receive window of the network device, and such that the uplink communication can be correctly decoded at the network device.

In some embodiments, determining the first round-trip delay between the UE and the network device comprises estimating the round-trip delay based on the synchronization request detection at the network device relative to a start of a synchronization request detection window; and determining the timing advance comprises adding the shift value to the estimated first round-trip delay.

In some embodiments, the synchronization request is a preamble message for a physical random access channel.

### BRIEF DESCRIPTION OF THE DRAWINGS

FIG. 1 illustrates an example of DAS configured for in-building deployment using a small cell base station as a signal source, in accordance with some embodiments.

FIG. 2 illustrates a flowchart of a process for synchronizing a UE with a network device, in accordance with some embodiments.

FIG. 3 illustrates an example timing schematic of the round-trip delay and the application of the timing advance, in accordance with some embodiments.

FIG. 4 illustrates an example of PRACH detection using PRACH short preamble format B4, in accordance with some embodiments.

FIG. 5 illustrates an example of the shifted round-trip delay detection range, in accordance with some embodiments.

FIG. 6 illustrates an example implementation of a computer system that may be used in connection with any of the embodiments of the disclosure provided herein.

### DETAILED DESCRIPTION

The inventors have developed new techniques to support base station synchronization with user equipment (UE). The techniques support time synchronization with extended round-trip delays between the base station and the UE, including network configurations such as distributed antenna systems. Distributed antenna systems include an array of antennas connected to a local network hub, such as a base station. The array of antennas is configured to provide wireless connectivity to devices across an area. Signals received by the array of antennas are then relayed to the shared local network hub. For large, distributed antenna systems, a variety of networking components may be used. For example, central area nodes, transport extension nodes, wide-area integration nodes, and/or access points may all be used to connect the array of antennas to the local network hub.

The inventors have recognized that the networking components may introduce propagation delay between the antennas of a distributed antenna system and the local network hub. The base station hardware used for processing the synchronization signals includes time duration limits for how long the system can correctly receive messages. For example, during the synchronization process, the base station will have a window of acceptance during which it expects to receive a message from the UE. When the message is not received during the acceptance window, the synchronization process may fail. As a result, due to the limited window of acceptance, conventional base station configurations may only support synchronization with a UE through distributed antenna systems when the system has a short round-trip delay.

Mobile networks provide wireless data communication to and from the UE (e.g., wireless mobile devices). To provide connectivity to UEs, base stations provide an interface between the wireless network accessed by UEs and the core network. To meet the increasing demand for cellular technology within buildings (e.g., stadiums, malls, and conference venues), components such as Distributed Antenna Systems (DAS) may be deployed for improved in-building wireless connectivity. A DAS includes two main components: a signal source and a distribution system. For 5G DAS deployment, a small cell base station may be used as the signal source. The distribution system provides communication between the signal source and the UE.

The distribution system usually includes a headend, fiber optic cables, remote units, and antennas. The inventors have recognized that the components of the distribution system introduce an intrinsic hardware delay to signals being transmitted between the signal source and the UE. For some configurations, the intrinsic delay may result in synchronization failures between the signal source and the UE. As DAS systems get larger and more complex, the risk of delay induced synchronization failure increases. For example, in a large DAS system, the DAS system may include central area nodes, transport extension nodes, wide-area integration nodes, and/or access points—each of which may increase the intrinsic delay of the system components.

Accordingly, the inventors have developed techniques for synchronizing a UE with a network device. Generally, the techniques can handle delays in the synchronization process that would otherwise fail in conventional systems. According to some embodiments, the techniques include using at least one computer hardware processor to perform: receiving, at the network device, a synchronization request (e.g., a preamble message for a physical random access channel) for establishing a data transmission session between the network device and the UE, wherein a detection window for the synchronization request is delayed by a shift value at the network device, the shift value being based on a stored network device delay (e.g., an intrinsic delay of hardware components and transport media); determining an estimated first round-trip delay between the UE and the network device based on the synchronization request received at the network device; determining a timing advance for the UE based on the estimated first round-trip delay and the shift value; and monitoring, by the network device, for an uplink communication based on the determined timing advance to be applied at the UE for the uplink communication.

In some examples, determining the timing advance for the UE comprises determining a value for the timing advance such that the uplink communication is expected to be received within the uplink receive window of the network device, and such that the uplink communication can be correctly decoded at the network device.

In some examples, the techniques further include receiving, within the uplink receive window, the uplink communication; and transmitting an identification signal to the UE based on the uplink communication.

In some examples, the techniques further include delaying a timing signal for the hardware by the shift value, wherein the hardware is configured to process messages from the UE (e.g., by configuring the shift value as a parameter in the PRACH detection module at the hardware by the PHY controller).

In some examples, determining the first round-trip delay between the UE and the network device comprises estimating the round-trip delay based on the synchronization request detection at the network device relative to a start of a synchronization request detection window; and determining the timing advance comprises adding the shift value to the estimated first round-trip delay.

In some examples, the format of the preamble message is a B4 format.

In some examples, a supported round-trip delay range is extended to be between 25 and 60 μs.

In some examples, the network device is a base station.

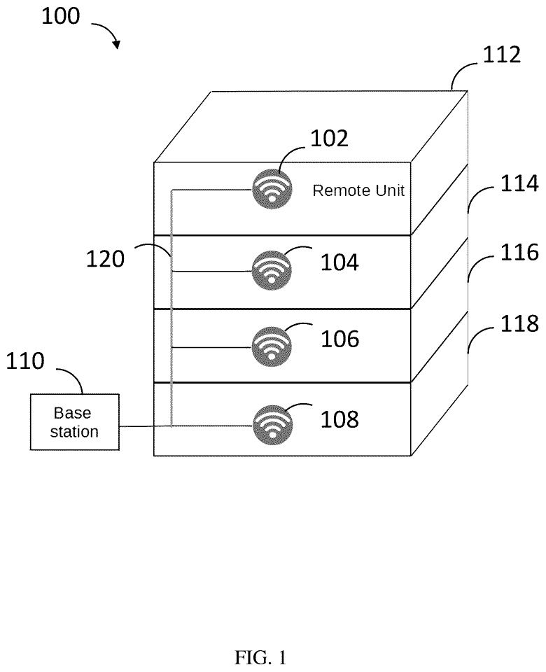

FIG. 1 illustrates an example of DAS 100 configured for in-building deployment using a small cell base station as a signal source, in accordance with some embodiments. DAS 100 includes base station 110 and remote units 102, 104, 106, and 108. Base station 110 is the signal source and the remote units are the distributed system. As shown in FIG. 1, DAS 100 includes remote units configured on different zones of a building. Remote unit 102 provides cellular network access to UEs in zone 112, remote unit 104 provides cellular network access to UEs in zone 112, remote unit 106 provides cellular network access to UEs in zone 116, and remote unit 108 provides cellular network access to UEs in zone 118. The remote units are communicatively connected to base station 110 through transport media 120.

Signals transmitted between the base station and the remote units will have a round-trip delay which depends on the configuration of the system components. For certain types of 5G DAS systems, the configuration may introduce a large round-trip delay between the base station and the remote units. In addition to the propagation delay, the intrinsic delay of the hardware and transport media contribute to the round-trip delay, as described above.

Transport media 120 may be any suitable transport media that can support the communication protocols between the base station and the remote units. In some embodiments, the transport media will be selected based on a desired communication bandwidth and/or speed. For example, the transport media may be twisted pair CAT6a cables. As another example, the transport media may be fiber optic cables. In other embodiments, other transport media may be used as aspects of the technology described herein are not limited in this respect.

Accordingly, for processing uplink and downlink signals (e.g., receiving and sending signals), synchronization between a base station and a UE has to be achieved. Typical mobile network synchronization processes rely on random access channel (RACH) processes. The RACH process involves a multi-message exchange between the UE and the base station. For example, in 5G system, a UE initiates communication with the base station by transmitting a physical random-access channel (PRACH) signal. An uplink random access signal can be transmitted at configured time-domain occasions based on the downlink synchronization signal, received at UE. The PRACH transmission is the first message (Msg 1) in the synchronization process. The base station responds to Msg 1 by transmitting a random-access response (RAR) message (Msg 2) to the UE. Msg 2 instructs the UE how much timing advance to use for the PUSCH transmission (Msg 3). A fourth message (Msg 4) is used for contention resolution.

Prior to Msg 1 transmission, the UE detects downlink synchronization signals which indicate a start of data frames. Based on the downlink synchronization signals, the UE decodes system information from an information block to determine the downlink and uplink configuration for the frame. Once the UE is synchronized to the downlink from the base station, the UE begins uplink synchronization by transmitting Msg 1 to the base station. In accordance with the data frame configuration of the base station, the base station includes a PRACH detection window during which it expects to receive a PRACH signal. If the PRACH signal is not received correctly during the PRACH detection window, the uplink synchronization procedure fails.

Prior to transmitting Msg 2, the base station estimates the round-trip delay from the PRACH transmission received as Msg 1. Specifically, the base station detects the preambles of the PRACH transmission to estimate the round-trip delay. For example, in 5G standard release 15, two types of PRACH sequences are defined based on the sequence length: long sequence with length L_RA=839 (e.g., PRACH long preamble formats) and short sequence with length L_RA=139 (e.g., PRACH short preamble formats). The estimated round-trip delay is then transmitted as a timing advance to the UE using Msg 2.

The UE uses the timing advance to transmit the Msg 3. As a result, this procedure maintains the orthogonality required for Orthogonal Frequency Division Multiplexing (OFDM). Accordingly, when orthogonality is maintained, the received PUSCH transmission does not interfere with the uplink transmissions of other UEs. Therefore, it is important that the base station correctly estimates the round-trip delay between base station and UE so that uplink transmissions are received within the uplink receive window.

The inventors have appreciated that when a 5G base station is connected to a 5G DAS with large round-trip delay, it is important to correctly estimate the round-trip delay in PRACH detection. One method for handling round-trip delay detection in systems with large round-trip delay is to use PRACH long preamble formats. For example, PRACH preamble format 0 can support round-trip delays up to 96 μs. However, PRACH long preamble formats cannot be used for all circumstances. For example, PRACH long preamble formats cannot be used when the TDD pattern limits the time duration supported between consecutive uplink (UP) slots. For example, TDD formats DDDSU or DDSU with 30 kHz subcarrier spacing do not provide enough time between consecutive UP slots to accommodate PRACH long preamble formats. As another example, some base station physical layer system-on-chip (SoC) systems cannot support PRACH long preamble formats. As another example, in frequency range 2 (e.g., 24.25 GHz to 52.6 GHz), PRACH long preamble formats are not supported. Accordingly, in these and other configurations which do not support PRACH long preamble formats, PRACH short preamble formats can be used.

The inventors have further appreciated that the maximum round-trip delay supported by the PRACH short preamble formats is usually shorter than that supported by PRACH long preamble formats. For example, the B4 PRACH preamble format, with typical PRACH detection, only supports a maximum round-trip delay around 15 μs in the 30 kHz subcarrier spacing. In certain 5G DAS systems, the additional round-trip delay introduced by DAS can be larger than 30 μs. Accordingly, the maximum supported round-trip delay for the B4 PRACH preamble format is shorter than the round-trip delay introduced in some 5G DAS systems.

The inventors have recognized that there may be PRACH detection issues when 5G DAS systems with large round-trip delays are connected to base stations when only PRACH short preamble formats can be used. Specifically, two issues in particular may interfere with synchronization between the UE and the base station: (1) incorrect PRACH preamble detection, and (2) incorrect estimation of round-trip delay. In either case, the issue will cause initial access failure at the UE. Accordingly, the usage scenario of 5G DAS could be limited if no process for handling the round-trip delay is applied at the base station for PRACH detection.

The inventors have developed techniques to support connections between 5G DAS with large round-trip delays and a base station such that the synchronization process supports PRACH short preamble formats. To accommodate round-trip delays larger than the maximum PRACH detection window, the inventors have developed techniques to delay a start of the PRACH detection window by a round-trip delay (RTD) shift.

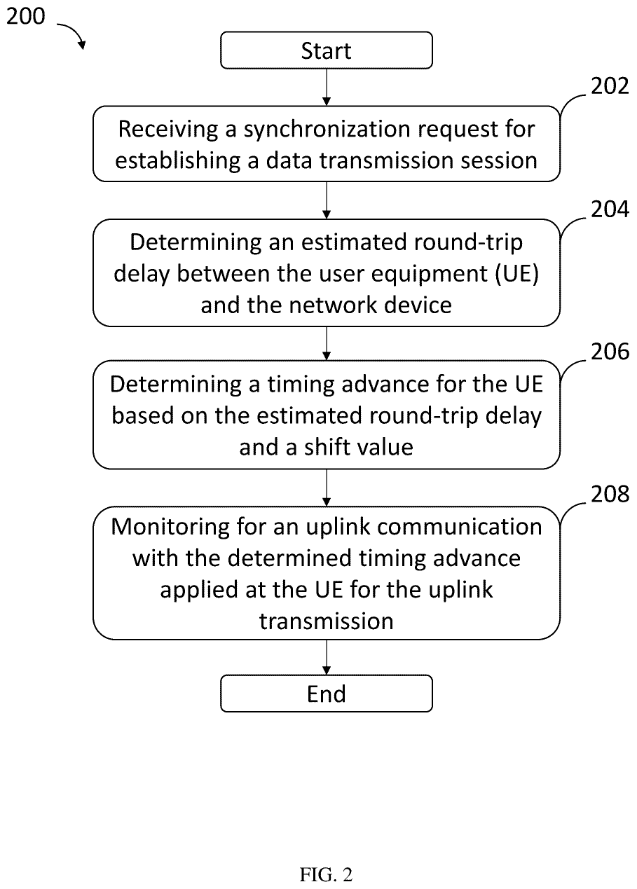

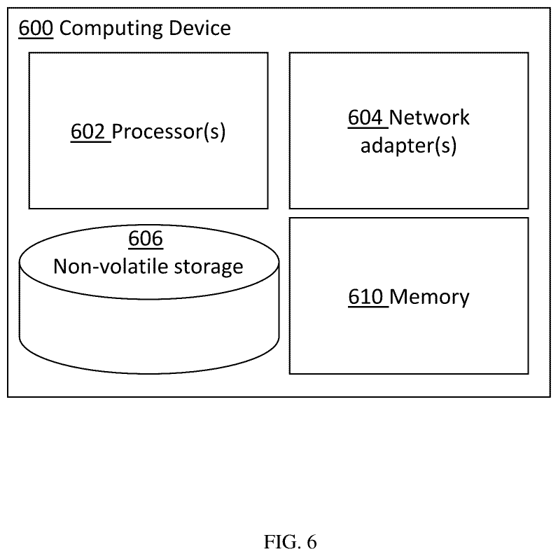

FIG. 2 illustrates a flowchart of a process 200 for synchronizing a UE with a network device, in accordance with some embodiments. Process 200 may be performed by any suitable computing device. For example, the computing device described below in connection with FIG. 6 may perform process 200. Prior to the start of process 200, the network device (e.g., base station) may obtain the hardware-introduced round-trip delay for the 5G DAS. In some embodiments, the hardware-introduced round-trip delay may be obtained by looking up the hardware specification. In some embodiments, a look up table including the delay values for respective combinations of network components may be used to obtain the hardware-introduced round-trip delay.

Process 200 starts at act 202 where the network device receives a synchronization request for establishing a data transmission session between the network device and the UE. The synchronization request detection is delayed by a shift value at the hardware. In some embodiments, the synchronization request detection is delayed by delaying a starting point of the PRACH detection window at the base station. For example, the starting point of the PRACH detection window may be delayed using a configurable value “RTD_Shift.” When applied, the RTD_Shift value changes the time that the starting point of the PRACH detection window occurs, thereby changing the temporal position of the window within which the PRACH signal may be received. Therefore, by postponing the PRACH detection starting point, it shifts the supported round-trip delay range of the base station to a larger range.

In some embodiments, the RTD_Shift parameter can be configured by software running on the base station, which provides the parameters for PRACH detection. In some embodiments, the RTD_Shift parameter can be configured by software running separately from the base station and communicated to the base station through a communication interface. In some embodiments, the shift value is transmitted to the hardware by delaying a timing signal to the hardware by the shift value.

In some embodiments, the shift value can be determined according to a DAS round-trip delay that was obtained previously. When determining the shift value, the value should be selected such that the shift is smaller than or equal to the DAS round-trip delay, and the shifted round-trip delay detection range of the base station can cover the overall round-trip delay of the DAS.

In some embodiments, the shift value (e.g., RTD_Shift) is based on a stored network device delay. As the device delay is based on the intrinsic delay of the hardware components and transport media, the process may further include identifying the hardware used in the DAS. After identifying the hardware components used in the DAS, respective delays associated with each of the components may be looked up. In some embodiments, the system may receive as a user input, during configuration, the identity of the hardware used in the DAS such that the delay value can be obtained using a look up table, such as tables 1 and 2 below.

TABLE 1
Transport Media Delay

| Transport | Velocity Factor | Propagation time per |
|---|---|---|
| Media | % | km |
| Air | 100 | 3.336 μs |
| Twisted Par | 65 | 5.132 μs |
| Cat-6A | | |
| Fiber | 68 | 4.905 μs |

Table 1 illustrates the propagation time per kilometer for three example transport media.

TABLE 2
Intrinsic Hardware Delay

| | Intrinsic System |
|---|---|
| Configuration | Delay (One-way) |
| CAN ↔ AP-1 | 18.2 μs |
| CAN ↔ TEN ↔ AP-1 | 19.4 μs |
| WIN(RFD) ↔ CAN ↔ TEN ↔ AP-1 | 20.7 μs |
| WIN(RFD) ↔ CAN ↔ TEN ↔ AP-1 ↔ AP-2 | 22.5 μs |
| WIN(CCD) ↔ CAN ↔ TEN ↔ AP-1 | 25.0 μs |
| WIN(CDD) ↔ CAN ↔ TEN ↔ AP-1 ↔ AP-2 | 27.5 μs |

Table 2 illustrates the one-way propagation times for several example hardware configurations. The example hardware configurations include central area nodes (CAN), transport extension nodes (TEN), wide-area integration nodes (WIN), and access points (AP). In some embodiments, the WIN may include a set of frequency-agnostic modules that are used across the wide-area integration node, central area node, and transport extension node. For example, a RF donor (RFD) card receives analog RF signals from base stations. As another example, a CPRI digital donor (CDD) receives CPRI digital signals from a baseband unit. In some embodiments, additional components and/or combinations of components may be used to generate a table similar to table 2 to facilitate determining the intrinsic hardware delay of the system components.

In some embodiments, the shift value may be selected from a previously used shift value. The base station may store previously used shift values and may select a shift value associated with the DAS when preparing for a synchronization process. For example, the previously shift delay values may be stored in a table associated with successful synchronization processes. In some embodiments, the shift value may be determined by testing the delay associated with the hardware components.

In some embodiments, the shift value may be obtained from a database that is separate from the base station. Previously used shift values may be stored in a database associated with the base station such that the base station may retrieve the shift values using a database look up protocol. In some embodiments, the database may include information specifying the hardware components associated with the DAS and base station such that upon retrieving information regarding the hardware components, the shift value may be determined.

Next, process 200 proceeds to act 204 where an estimated first round-trip delay between the UE and the network device is determined based on the synchronization request detection at the network device. The estimated first round-trip delay is determined based on the preamble included in the synchronization request (e.g., Msg 1). For example, when a PRACH preamble is detected by the base station, a round-trip delay is estimated.

Next, process 200 proceeds to act 206 where a timing advance for the UE is determined based on the estimated first round-trip delay and the shift value. Determining the timing advance includes determining a value for the timing advance such that the uplink communication is expected to be received within the uplink receive window of the network device. By ensuring that the uplink communication arrives within the expected uplink receive window, the uplink communication can be correctly decoded at the network device. For determining a timing advance, an estimated first round-trip delay is determined (RTD_PRACH_Det). In some embodiments, the first round-trip delay is estimated based on the synchronization request detection at the network device relative to the start of a synchronization request detection window. The synchronization request detection window is delayed by the shift value, accordingly the estimated first round-trip delay will be an underestimate of the actual round-trip delay. Accordingly, the actual round-trip delay (RTD_Actual) is given by equation 1, below.

$${RTD}_{Actual} = {RTD}_{{PRACH}_{Det}} + {RTD}_{Shift} \qquad Equation 1$$

The actual round-trip delay is used for generating the timing advance information used in the RAR. The RAR is used to instruct the UE how much timing advance is to be applied to the Msg 3 PUSCH transmission.

Next, process 200 proceeds to act 208 where the network device monitors for an uplink communication with the determined timing advance applied at the UE for the uplink transmission. Upon receiving the timing advance, the UE applies the timing advance to the transmission time to compensate for the overall round-trip delay such that the Msg 3 transmission appears to arrive at the base station without experiencing delay. Accordingly, following the transmission of Msg 2, the base station waits to receive Msg 3 as a response from the UE.

Following act 208, process 200 concludes. Following the conclusion of process 200, the base station may transmit a contention resolution message (Msg 4) to the UE to resolve conflicts between multiple UEs. Following the end of the synchronization process, the UE and the base station may exchange data packets in accordance with uplink and downlink protocols.

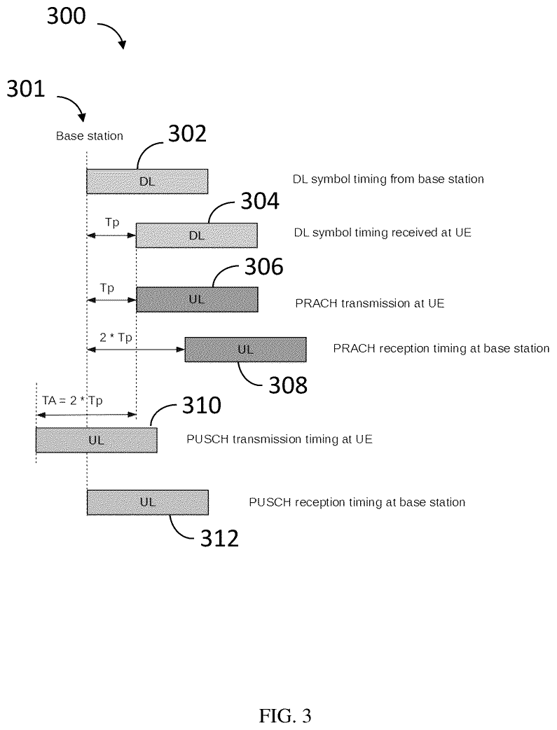

FIG. 3 illustrates an example timing schematic 300 of the round-trip delay and the application of the timing advance, in accordance with some embodiments. Timing schematic 300 illustrates the timing of downlink symbol transmissions, PRACH transmissions, and PUSCH transmission from the perspective of the base station. Base station reference time 301 represents the time that downlink signals are transmitted by the base station, and reference time 301 represents the time that uplink signals are expected to arrive at the base station. For example, for uplink signal, the base station reference time 301 may represent the beginning of an uplink receiving window.

Timing schematic 300 includes downlink symbol transmission for downlink synchronization with the UE. The downlink symbol transmission provides synchronization information for the UE to configure a preamble transmission to initiate an uplink synchronization process, as described herein. The downlink symbol transmission is transmitted from the base station with timing 302. For example, timing 302 may be the beginning of a downlink portion of a data frame. As another example, timing 302 may correspond to a set time interval relative to the start of the data frame. The downlink symbol transmission is received by the UE at timing 304. The difference between the leading edge of timing 302 and timing 304 represents the one-way time delay (Tp) in the system (e.g., the time it takes for a transmission to travel from the base station to the UE). Accordingly, the one-way delay depends on the distance between the UE and the base station Tx/Rx point. Therefore, it represents the amount of time it takes for the signal to travel from the sender to the receiver (e.g., the propagation delay). Additionally, the interface between the base station and its transmitting/receiving (Tx/Rx) point impacts the one-way delay. For example, when the antennas are directly connected to the base station output points, the propagation delay may be negligible. However, as described herein, when the base station is connected to a DAS the processing at the DAS and/or transport media may introduce additional delay, resulting in a large delay for signal transmission between base station and its Tx/Rx point.

Timing schematic 300 includes uplink transmission of PRACH (Msg 1) from the UE to the base station. As shown in FIG. 3, the PRACH message is transmitted from the UE at timing 306, in response to receiving the downlink symbol transmission at timing 304. Accordingly, the transmission by the UE of the PRACH transmission will be delayed, relative to the timing of the base station, by the one-way delay. In some embodiments, the transmission timing 306 will be further delayed by the processing time of the UE. Following transmission by the UE, the PRACH message is received by the base station at time 308. Relative to the base station's reference time, the PRACH message receive timing 308 is delayed by the round-trip time (2*Tp; e.g., twice the one-way delay).

Upon receipt of the PRACH message the base station estimates the round-trip delay to determine the timing advance that will synchronize the UE and the base station. After the UE implements the timing advance, decoded from Msg 2, the UE transmits a PUSCH transmission (Msg 3) at timing 310. As shown in FIG. 3, timing 310 is advanced from the UE received downlink symbol reference by the round-trip delay. Due to the advance, the PUSCH message is received at the base station at time 312, synchronized with the base station's reference time 301.

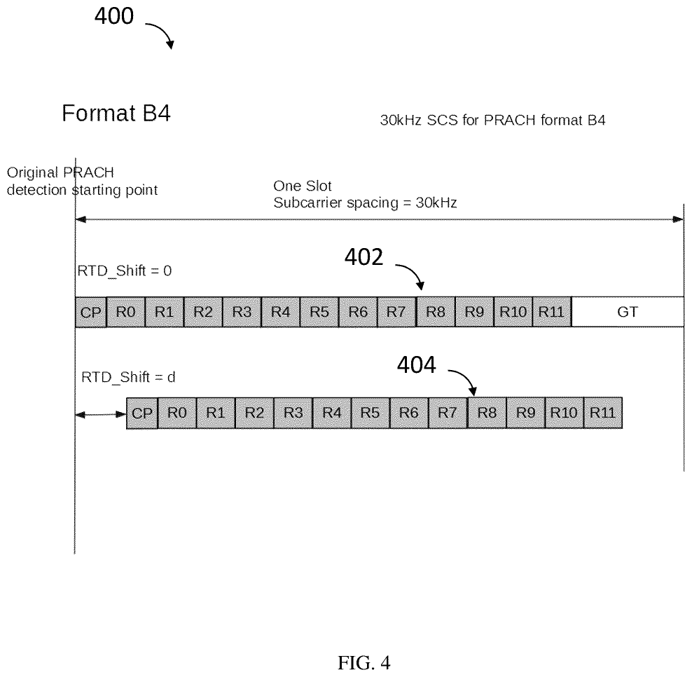

FIG. 4 illustrates an example of PRACH detection 400 using PRACH short preamble format B4, in accordance with some embodiments. As shown in FIG. 4, the PRACH short preamble format B4 at 30 kHz subcarrier spacing starts with the cyclic prefix (CP) transmission which is followed by 12 repeated sequences. In the absence of a shift value (RTD_Shift) the detection range (e.g., the time window within which the PRACH message needs to be received to proceed with synchronization) is 0 to RTD_Max (e.g., the maximum round-trip delay supported by the base station using the given PRACH preamble format). However, when the shift value is applied the detection range is shifted by RTD_Shift such that the detection window ranges between RTD_Shift and RTD_Shift+RTD_Max.

As shown in FIG. 4, a received PRACH message 402 without a delay arrives at the beginning of the PRACH detection window (e.g., the PRACH detection starting point) with an RTD_Shift of zero. When the uplink received signal is delayed by a non-zero round-trip delay (d), the received PRACH message 404 does not arrive at the beginning of the PRACH detection window. However, when applying the RTD_Shift, d, the PRACH detection starting point will be shifted to the start of the received PRACH message 404. Although the preamble illustrated in FIG. 4 is a B4 format, the frame may use any suitable preamble format in accordance with the standard protocols. For example, the preamble format may be an A1, A2, A3, B1, B2, C0, or C2 format. In some embodiments, other preamble formats may be used, as aspects of the technology described herein are not limited in this respect.

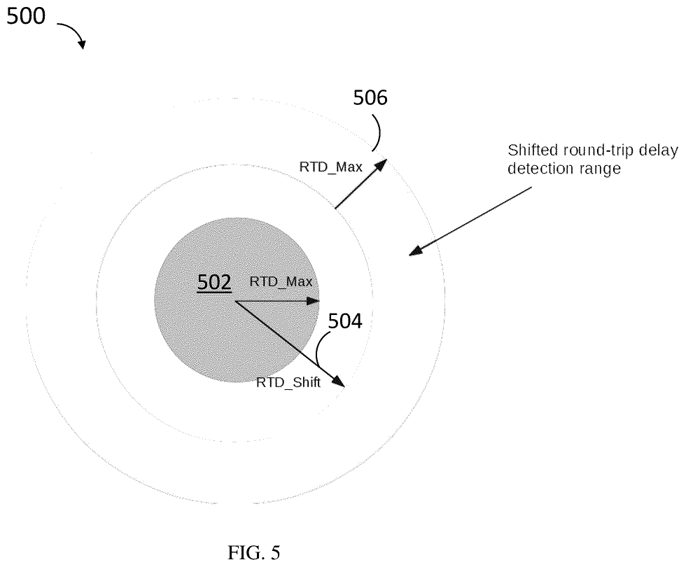

FIG. 5 illustrates an example of the shifted round-trip delay detection range, in accordance with some embodiments. In FIG. 5, the center of the concentric circles represents the zero round-trip delay between the base station and the UE. The inner circle 502 represents the PRACH detection window without any RTD_Shift applied at the base station. The outer circle 506 represents the shifted PRACH detection window when an RTD_Shift 504 is applied on the PRACH detection starting point.

In some embodiments, the PRACH detection window is extended to between 25 to 60 μs, by applying different RTD_Shift values on the PRACH detection starting point at the base station, in accordance with the stored network device delay in different hardware configurations. It should be appreciated that the detection window can be extended by any desired duration and/or range of durations. For example, the detection window may be extended to between 25 and 35 μs, between 25 and 45 μs, between 25 and 55 μs, or between 25 and 60 μs.

FIG. 6 illustrates an example implementation of a computer system 600 that may be used in connection with any of the embodiments of the disclosure provided herein. For example, process 200 may be performed using computing system 600. The computing system 600 may include one or more computer hardware processors 602 and one or more non-transitory computer-readable storage media. For example, one or more volatile storage devices 610 and/or one or more non-volatile storage devices 606 (e.g., a hard disk, a flash memory, etc.) may be included with computing system 600. The hardware processor 602 may control writing data to and reading data from the volatile storage device 610 and the non-volatile storage device 606, which may serve as non-transitory computer-readable storage media storing processor-executable instructions for execution by the hardware processor 602.

Computing system 600 may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone, tablet, or any other suitable portable or fixed electronic device, as aspects of the technology described herein are not limited in this respect.

Also, a computer may have one or more input and output devices. These devices may be used, among other things, to present a user interface. Examples of output devices that may be used to provide a user interface include printers or display screens for visual presentation of output and speakers or other sound generating devices for audible presentation of output. Examples of input devices that may be used for a user interface include keyboards, and pointing devices, such as mice, touch pads, and digitizing tablets. As another example, a computer may receive input information through speech recognition or in other audible format.

Such computers may be interconnected by one or more networks in any suitable form, including as a local area network or a wide area network, such as an enterprise network or the Internet. Such networks may be based on any suitable technology and may operate according to any suitable protocol and may include wireless networks, wired networks, fiber optic networks, or any suitable combination thereof.

Having thus described several aspects of at least one embodiment of the technology described herein, it is to be appreciated that various alterations, modifications, and improvements will readily occur to those skilled in the art.

Such alterations, modifications, and improvements are intended to be part of this disclosure and are intended to be within the spirit and scope of disclosure. Further, though advantages of the technology described herein are indicated, not every embodiment of the technology described herein will include every described advantage. Some embodiments may not implement any features described as advantageous herein and in some instances one or more of the described features may be implemented to achieve further embodiments. Accordingly, the foregoing description and drawings are by way of example only.

The above-described embodiments of the technology described herein may be implemented in any of numerous ways. For example, the embodiments may be implemented using hardware, software, or a combination thereof. When implemented in software, the software code may be executed on any suitable processor or collection of processors, whether provided in a single computer or distributed among multiple computers. Such processors may be implemented as integrated circuits, with one or more processors in an integrated circuit component, including commercially available integrated circuit components known in the art by names such as CPU chips, GPU chips, microprocessor, microcontroller, or co-processor. Alternatively, a processor may be implemented in custom circuitry, such as an ASIC, or semicustom circuitry resulting from configuring a programmable logic device. As yet a further alternative, a processor may be a portion of a larger circuit or semiconductor device, whether commercially available, semi-custom or custom. As a specific example, some commercially available microprocessors have multiple cores such that one or a subset of those cores may constitute a processor. However, a processor may be implemented using circuitry in any suitable format.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, aspects of the technology described herein may be embodied as a computer readable storage medium (or multiple computer readable media) (e.g., a computer memory, one or more floppy discs, compact discs (CD), optical discs, digital video disks (DVD), magnetic tapes, flash memories, circuit configurations in Field Programmable Gate Arrays or other semiconductor devices, or other tangible computer storage medium) encoded with one or more programs that, when executed on one or more computers or other processors, perform methods that implement the various embodiments described above. As is apparent from the foregoing examples, a computer readable storage medium may retain information for a sufficient time to provide computer-executable instructions in a non-transitory form. Such a computer readable storage medium or media may be transportable, such that the program or programs stored thereon may be loaded onto one or more different computers or other processors to implement various aspects of the technology as described above. As used herein, the term “computer-readable storage medium” encompasses only a non-transitory computer readable medium that may be considered to be a manufacture (i.e., article of manufacture) or a machine. Alternatively or additionally, aspects of the technology described herein may be embodied as a computer readable medium other than a computer-readable storage medium, such as a propagating signal.

The terms “program” or “software” are used herein in a generic sense to refer to any type of computer code or set of processor-executable instructions that may be employed to program a computer or other processor to implement various aspects of the technology as described above. Additionally, one or more computer programs that when executed perform methods of the technology described herein need not reside on a single computer or processor, but may be distributed in a modular fashion amongst a number of different computers or processors to implement various aspects of the technology described herein.

Processor-executable instructions may be in many forms, such as program modules, executed by one or more computers or other devices. Generally, program modules include routines, programs, objects, components, data structures, etc. that perform particular tasks or implement particular abstract data types. Typically, the functionality of the program modules may be combined or distributed.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, for example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B,” when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

Use of ordinal terms such as “first,” “second,” “third,” etc., in the claims to modify a claim element does not by itself connote any priority, precedence, or order of one claim element over another or the temporal order in which acts of a method are performed. Such terms are used merely as labels to distinguish one claim element having a certain name from another element having a same name (but for use of the ordinal term). The phraseology and terminology used herein is for the purpose of description and should not be regarded as limiting. The use of “including,” “comprising,” “having,” “containing,” “involving,” and variations thereof, is meant to encompass the items listed thereafter and additional items.

Unless otherwise specified, the terms “approximately,” “substantially,” and “about” may be used to mean within ±10% of a target value in some embodiments. The terms “approximately,” “substantially” and “about” may include the target value.

What is claimed is:

1. A method of synchronizing a user equipment (UE) with a network device, the method comprising:
using at least one computer hardware processor to perform:
receiving, at the network device, a synchronization request for establishing a data transmission session between the network device and the UE, wherein a detection window for the synchronization request is delayed by a shift value at the network device, the shift value being based on a stored network device delay;
determining an estimated first round-trip delay between the UE and the network device based on the synchronization request received by the network device;
determining a timing advance for the UE based on the estimated first round-trip delay and a shift value; and
monitoring, by the network device, for an uplink communication based on the determined timing advance to be applied at the UE for the uplink communication.

2. The method of claim 1, further comprising obtaining the stored network device delay based on intrinsic delay of hardware components and transport media.

3. The method of claim 1, wherein determining the timing advance for the UE comprises determining a value for the timing advance such that the uplink communication is expected to be received within the uplink receive window of the network device, and such that the uplink communication can be correctly decoded at the network device.

4. The method of claim 1, further comprising:
receiving, within the uplink receive window, the uplink communication; and
transmitting an identification signal to the UE based on the uplink communication.

5. The method of claim 1, further comprising delaying a timing signal for the hardware by the shift value, and wherein the hardware is configured to process messages arriving from the UE.

6. The method of claim 1, wherein:
determining the first round-trip delay between the UE and the network device comprises estimating the round-trip delay based on the synchronization request detection at the network device relative to a start of a synchronization request detection window; and
determining the timing advance comprises adding the shift value to the estimated first round-trip delay.

7. The method of claim 1, wherein the synchronization request is a preamble message for a physical random access channel.

8. The method of claim 7, wherein a format of the preamble message is a B4 format.

9. The method of claim 1, wherein a window of overall round-trip delay detection range is extended to be between 25 to 60 μs.

10. The method of claim 1, wherein the timing advance is transmitted to the UE using a random access response signal.

11. The method of claim 1, wherein the network device is a base station.

12. A system comprising,
at least one computer hardware processor; and
at least one non-transitory computer-readable storage medium storing processor executable instructions that, when executed by the at least one computer hardware processor, cause the at least one computer hardware processor to perform a method for synchronizing a user equipment (UE) with a network device, the method comprising:
receiving, at the network device, a synchronization request for establishing a data transmission session between the network device and the UE, wherein a detection window for the synchronization request is delayed by a shift value at the network device, the shift value being based on a stored network device delay;
determining an estimated first round-trip delay between the UE and the network device based on the synchronization request received by the network device;
determining a timing advance for the UE based on the estimated first round-trip delay and a shift value; and
monitoring, by the network device, for an uplink communication based on the determined timing advance to be applied at the UE for the uplink communication.

13. The system of claim 12, further comprising obtaining the stored network device delay based on intrinsic delay of hardware components and transport media.

14. The system of claim 12, wherein determining the timing advance for the UE comprises determining a value for the timing advance such that the uplink communication is expected to be received within the uplink receive window of the network device, and such that the uplink communication can be correctly decoded at the network device.

15. The system of claim 12, wherein:
determining the first round-trip delay between the UE and the network device comprises estimating the round-trip delay based on the synchronization request detection at the network device relative to a start of a synchronization request detection window; and
determining the timing advance comprises adding the shift value to the estimated first round-trip delay.

16. At least one non-transitory computer-readable storage medium storing processor executable instructions that, when executed by at least one computer hardware processor, cause the at least one computer hardware processor to perform a method for synchronizing a user equipment (UE) with a network device, the method comprising:
receiving, at the network device, a synchronization request for establishing a data transmission session between the network device and the UE, wherein a detection window for the synchronization request is delayed by a shift value at the network device, the shift value being based on a stored network device delay;
determining an estimated first round-trip delay between the UE and the network device based on the synchronization request received by the network device;
determining a timing advance for the UE based on the estimated first round-trip delay and a shift value; and
monitoring, by the network device, for an uplink communication based on the determined timing advance applied at the UE for the uplink communication.

17. The at least one non-transitory computer-readable storage medium of claim 16, further comprising obtaining the stored network device delay based on intrinsic delay of hardware components and transport media.

18. The at least one non-transitory computer-readable storage medium of claim 16, wherein determining the timing advance for the UE comprises determining a value for the timing advance such that the uplink communication is expected to be received within the uplink receive window of the network device, and such that the uplink communication can be correctly decoded at the network device.

19. The at least one non-transitory computer-readable storage medium of claim 16, wherein:
determining the first round-trip delay between the UE and the network device comprises estimating the round-trip delay based on the synchronization request detection at the network device relative to a start of a synchronization request detection window; and
determining the timing advance comprises adding the shift value to the estimated first round-trip delay.

20. The at least one non-transitory computer-readable storage medium of claim 16, wherein the synchronization request is a preamble message for a physical random access channel.
